(19) United States
(12) Patent Application Publication
(10) Pub. No.: US 2016/0022390 A1
(43) Pub. Date: Jan. 28, 2016

(54) MILLING BLANK FOR AN ABUTMENT ATTACHMENT

(71) Applicants: Bruno SPINDLER, (US); Curd GADAU, (US)

(72) Inventors: Bruno SPINDLER, Oppenau (DE); Curd GADAU, Bessenbach (DE)

(21) Appl. No.: 14/775,116

(22) PCT Filed: Mar. 11, 2014
(86) PCT No.: PCT/EP2014/054686

§ 371 Date: Sep. 11, 2015

(30) Foreign Application Priority Data
Mar. 11, 2013 (DE) 10 2013 102 402.5

(51) Int. Cl. A61C 13/00; A61C 8/00

(52) U.S. Cl. CPC A61C 13/0022; A61C 8/0068; A61C 8/006; A61C 13/0004

(57) ABSTRACT

A milling blank for an abutment attachment which can be secured to a dental implant, including a securing section with a screw channel for a fixing screw for securing the milled abutment attachment to the dental implant; and a milling section having a feed channel at an angle with respect to the screw channel for feeding the fixing screw into the screw channel.

The present invention relates to a milling blank for an abutment attachment, a method for producing an abutment attachment and a computer program product for a programmable milling device.

The document EP 2 343 025 A2 describes a milling blank for an abutment attachment having a central, straight screw channel for the insertion of a fixing screw and for securing the milled abutment attachment.

However, if an abutment attachment having a laterally offset or asymmetric adhesive base is produced from the milling blank, the central screw channel will be partly exposed at the side. As a result, the adhesive surface of the adhesive base is reduced, as is the stability of the abutment attachment.

The object on which the invention is based is to specify a milling blank with which it is possible to produce an abutment attachment with a laterally offset adhesive base which exhibits high stability and a large adhesive area.

This object is achieved by subjects having the features as claimed in the independent claims. Advantageous embodiments of the invention are the subjects of the figures, the description and the dependent claims.

According to a first aspect of the invention, the object is achieved by a milling blank for an abutment attachment which can be secured to a dental implant, comprising a securing section having a screw channel for a fixing screw for securing the milled abutment attachment to the dental implant; and a milling section having a feed channel angled with respect to the screw channel for feeding the fixing screw to the screw channel. The screw channel and the feed channel have a cylindrical outline, for example. The milling section has a larger diameter than the securing section, for example, and is used for milling out the abutment attachment.

The technical advantage which is achieved as a result, for example, is that following the production of an abutment attachment having a laterally offset or asymmetric adhesive base, the feed channel runs in the interior of the abutment attachment and the adhesive surface is increased. The milling blank with angled feed channel is used for further processing on milling centers in laboratories or practices, so that an individual abutment attachment can be created.

In an advantageous embodiment of the milling blank, the screw channel comprises a conical section for the insertion of a fixing screw with conical neck. The technical advantage that is achieved as a result, for example, is that a flush fixing screw with a conical neck can be used. Using such a fixing screw, a form-fitting connection is produced and the force exerted is distributed over a large area. Cavities in which bacteria can accumulate are minimized. As a result of the conical configuration, the entire transition from the implant to the abutment attachment is reinforced considerably as compared with a conventional screw with head and straight shank. The stability of the abutment attachment is increased by a quarter in this way.

In a further advantageous embodiment of the milling blank, the angle of the feed channel with respect to the screw channel corresponds to half the opening angle of the conical section. The technical advantage that is achieved as a result, for example, is that a smooth and seamless transition between feed channel and screw channel can be implemented.

In a further advantageous embodiment of the milling blank, the conical section has a height of 1 mm to 5 mm. The technical advantage that is achieved as a result is, for example, that the stability of the milled and inserted abutment attachment is improved.

In a further advantageous embodiment of the milling blank, the conical section is arranged in the securing section. The technical advantage that is achieved as a result is, for example, that a straight feed channel is formed within the milling section and the stability of the milling blank and of the abutment attachment milled therefrom is improved.

In a further advantageous embodiment of the milling blank, the conical section has a titanium nitride coating, a diamond coating or a carbon coating. The technical advantage that is achieved as a result is, for example, that the fixing screw can be screwed in smoothly with respect to the conical section.

In a further advantageous embodiment of the milling blank, the milling section is cylindrical. The technical advantage that is achieved as a result is, for example, that the milling section can be machined uniformly during milling.

In a further advantageous embodiment of the milling blank, the securing section is arranged on the axis of the cylindrical milling section. The technical advantage that is achieved as a result is, for example, that the milling blank can be inserted into a milling tool by the securing section.

In a further advantageous embodiment of the milling blank, the feed channel merges seamlessly into the screw channel. The technical advantage that is achieved as a result is, for example, that canting of the fixing screw during insertion is prevented.

In a further advantageous embodiment of the milling blank, an opening of the feed channel is located in the edge region of a surface of the milling section that is opposite the securing section. The technical advantage that is achieved as a result is, for example, that a high inclination of the feed channel is achieved.

In a further advantageous embodiment of the milling blank, the securing section widens toward the milling section. The technical advantage that is achieved as a result is, for example, that the securing section forms a stable base for the milling section.

In a further advantageous embodiment of the milling blank, the securing section comprises a hexagonal section for insertion into a hexagonal recess. The technical advantage that is achieved as a result is, for example, that the securing section has an interface to all leading implants.

In a further advantageous embodiment of the milling blank, the angle between the screw channel and the feed channel is in the range from 5° to 20°. The angle between the screw channel and the feed channel is preferably 11°. The technical advantage that is achieved as a result is, for example, that the feed channel is located in a particularly suitable angular range, in which both insertion of the fixing screw and the production of an abutment attachment with a lateral offset are made possible.

In a further advantageous embodiment of the milling blank, the feed channel is widened in the area of the connection to the screw channel. The technical advantage that is achieved as a result is, for example, that insertion of the fixing screw into the screw channel via the feed channel is made easier.

In a further advantageous embodiment of the milling blank, the milling blank comprises a central recess for the insertion of a turning tool on a surface of the milling section that is located opposite the securing section. The technical advantage that is achieved as a result is, for example, that the milling blank can be inserted into a turning tool in a straightforward way.

According to a second aspect of the invention, the object is achieved by a method for producing an abutment attachment comprising the step of milling a milling blank as claimed in the first aspect. The technical advantage that is achieved as a result is, for example, that the abutment attachment can be produced in a straightforward way.

In an advantageous embodiment of the method, the method comprises the step of processing a data set which defines a physical area around the feed channel within the milling blank in which no machining of the milling blank is carried out by the method. The technical advantage that is achieved as a result is, for example, that a channel wall thickness of the milled abutment attachment around the angled feed channel has a predefined minimum thickness.

According to a third aspect of the invention, the object is achieved by a computer program product which comprises a program which can be loaded directly into a memory of a programmable milling device, comprising programming means for milling a milling blank as claimed in the first aspect, wherein the computer program product further comprises a data set which defines a physical area around the angled feed channel within the milling blank in which no machining of the milling blank is carried out by the milling device or machining of the milling blank by the milling device is not done. The technical advantage that is likewise achieved as a result is, for example, that a channel wall thickness of the milled abutment attachment around the angled feed channel has a predefined minimum thickness.

Exemplary embodiments of the invention are illustrated in the drawings and will be described in more detail below.

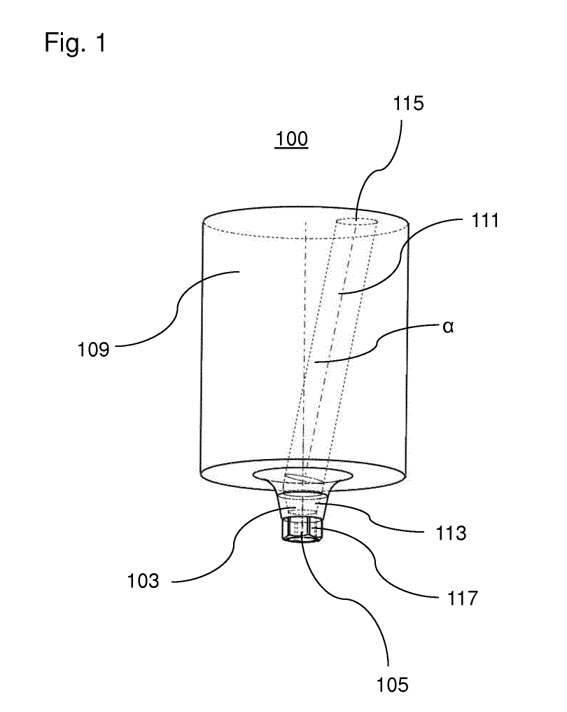

FIG. 1 shows a view of a milling blank with angled feed channel;

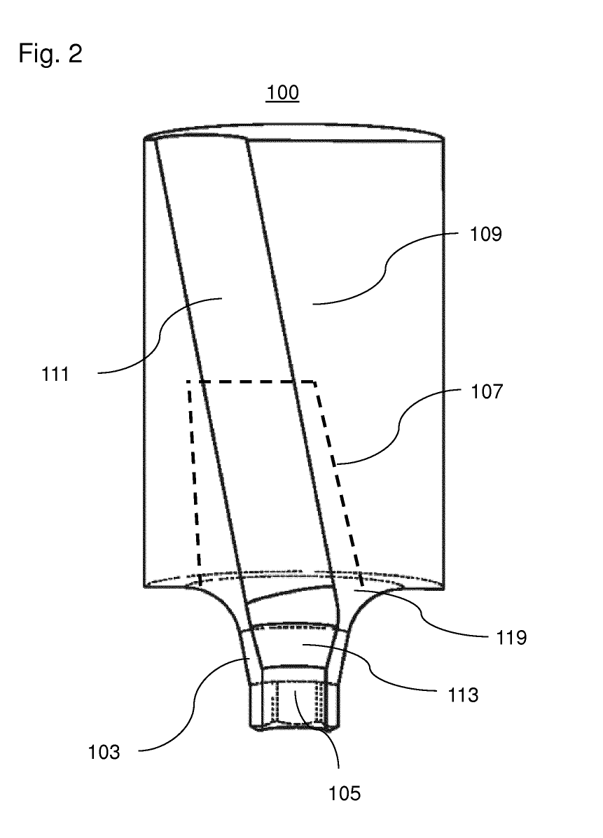

FIG. 2 shows a cross-sectional view of the milling blank;

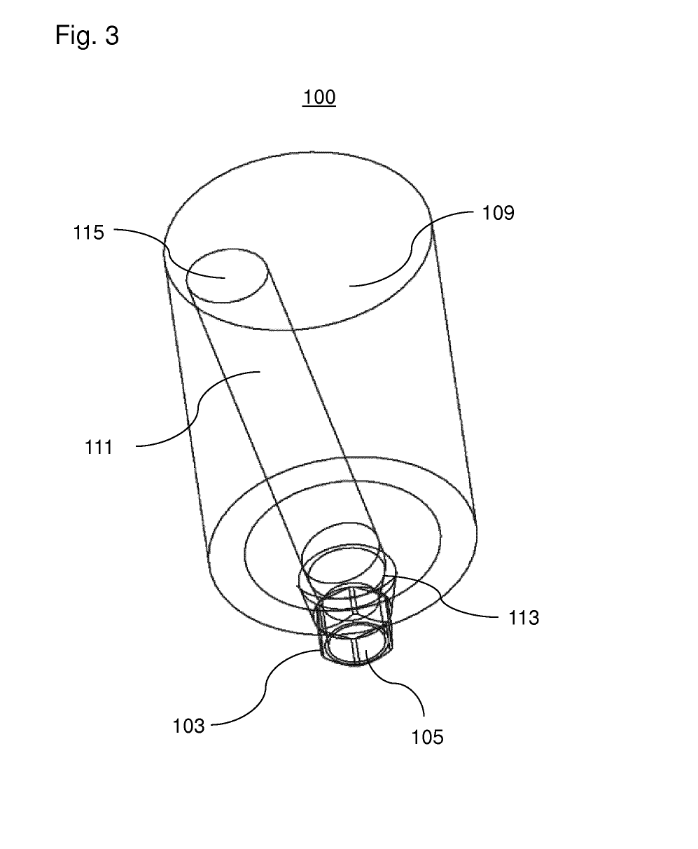

FIG. 3 shows a further view of the milling blank;

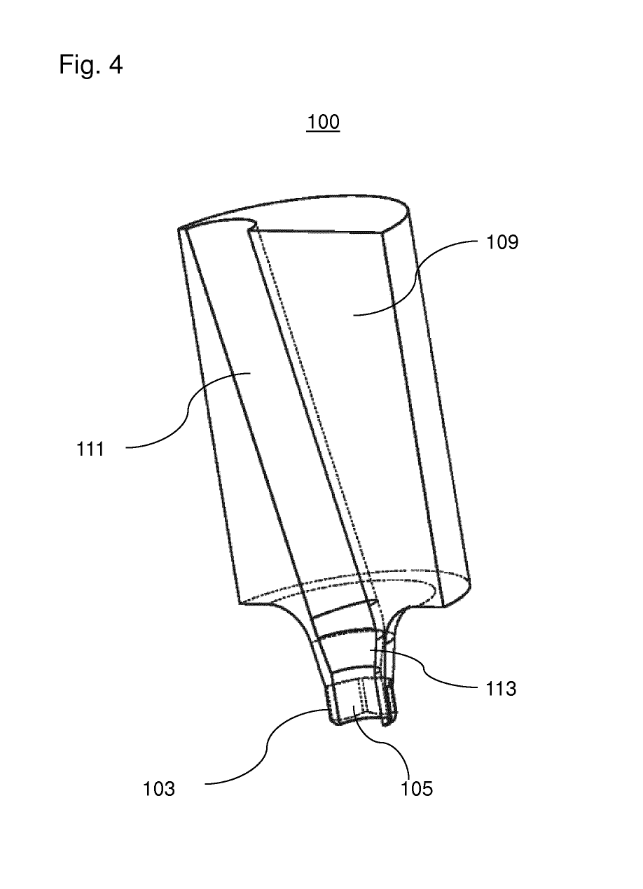

FIG. 4 shows a further cross-sectional view of the milling blank; and

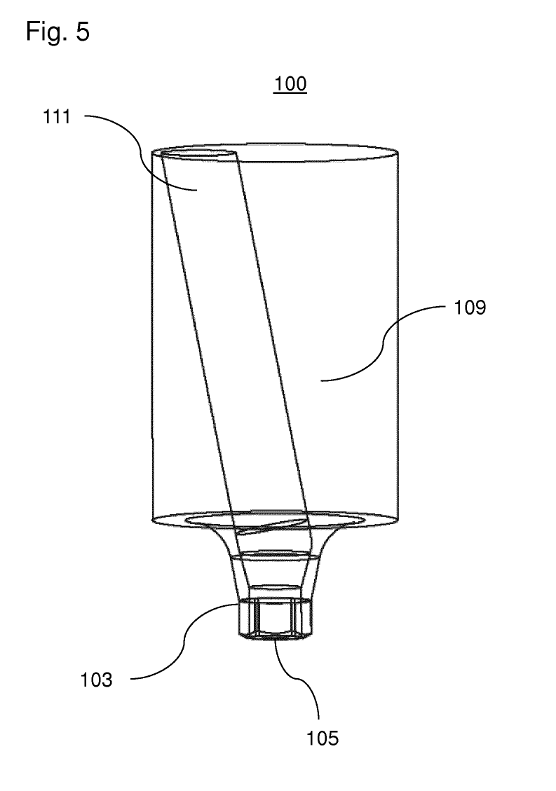

FIG. 5 shows a further view of the milling blank.

FIG. 1 shows a view of a milling blank 100 having a cylindrical feed channel 111 for a fixing screw, which is angled with respect to a cylindrical screw channel 105. The milling blank 100 is used to produce an abutment attachment which, as an add-on part, is secured to a dental implant for a dental prosthesis. The milled abutment attachment comprises an adhesive base which, for example, is used to bond an adhesive element on. By means of individual milling of the milling blank, it is possible to produce an abutment attachment that is matched to the patient.

The milling blank 100 can be produced, for example, from grade 5 titanium (Ti-6Al-4V), so that a high strength with good ductility with a simultaneously low density is provided. In particular, this material provides good milling characteristics. In general, however, other suitable materials can also be used.

The milling blank 100 comprises a prefabricated securing section 103, which is used to secure the milled abutment attachment to the dental implant and is not processed further for this purpose. This securing section 103 forms, for example, a prefabricated interface to all leading implants. For this purpose, the securing section 103 has, for example, a hexagonal section 117 for insertion into a hexagonal recess of the dental implant

Located in the securing section 103 is a screw channel 105, into which a fixing screw for securing the abutment attachment to the dental implant is introduced. The fixing screw exerts a force on the abutment attachment following tightening via the screw channel 105, so that said attachment is seated firmly and non-rotatably on the dental implant. The screw channel 105 has a conical section 113.

Within the milling section 109 there extends a feed channel 111, angled by the angle α with respect to the screw channel 105, for feeding the fixing screw to the screw channel 105. The opening 115 of the feed channel 111 is located on the top of the cylindrical milling section 109.

FIG. 2 shows a cross-sectional view of the milling blank 100, in which a possible shape of the abutment attachment 107 is shown. The fixing screw is inserted from above into the feed channel 111 and then slides into the screw channel 105 for fixing the finished abutment attachment 107. The screw channel 105 has a conical section 113 for the insertion of a fixing screw with conical neck which widens towards the top. This achieves the advantage that it is possible to use a fixing screw with conical neck, which transfers the pressing force over a large area to the milled abutment attachment 107 and, on account of its conical form, improves the strength and stability of the entire structure.

The angle of the feed channel 111 with respect to the screw channel 105 corresponds to half the opening angle of the conical section 113. As a result, in a subregion between the feed channel 111 and the conical section 113, it is possible to achieve a straight transition, so that an inserted fixing screw can slide into the screw channel 105 without hindrance. Otherwise, the transition between the feed channel 111 and the conical section 113 is rounded, so that the feed channel 111 merges seamlessly into the screw channel 105.

The feed channel 111 and the screw channel 105 are shaped in such a way that it is possible to use an inverse socket fixing screw (inverse socket), such as a screw with a hexagonal projection, for example, by means of which considerably lower force peaks are produced during the fixing.

The conical section 113 has a height from 1 mm to 5 mm, for example, and is formed completely within the securing section 103. In addition, in the region of the conical section, the milling blank 100 can be provided with a coating made of titanium nitride, diamond or carbon material, so that the fixing screw can be tightened with little resistance.

The securing section 103 merges continuously and without corners into the milling section 109, which is formed by a cylindrical milled body. For this purpose, the securing section 103 comprises a transition section 119, which merges continuously into the milling section 109. The contour of the transition section 119 has a concave, inwardly curved form. As a result, on the outer side of the milling blank 100, a transition that has no edges or corners can be achieved between the securing section 103 and the milling section 109, and the stability of the abutment attachment is improved. The individual part of the abutment attachment is produced from the milling blank 100 during the further processing on milling centers in laboratories or practices.

FIG. 3 shows a further view of the milling blank 100. The opening 115 of the feed channel 111 is located in the edge region of the circular surface that is formed by the top of the cylindrical milling section 109. In general, the feed channel 111 in the area of the connection to the screw channel 105 can likewise have a widening with respect to a cylindrical shape. The widening is produced, for example, in that during the production of the milling blank 100, the feed channel 111 is additionally milled out in the transition region to the screw channel 105. This achieves the advantage that larger angles between feed channel 111 and screw channel 105 can be realized, since the fixing screw can be guided around the angled point in the interior of the milled abutment attachment.

FIG. 4 shows a further cross-sectional view of the milling blank 100. The securing section 103 widens increasingly toward the milling section 109, so that on the outer side of the milling blank 100, a smooth and edge-free transition between the securing section 103 and the milling section 109 is achieved. This achieves the advantage that the largest possible part of the abutment attachment is prefabricated and does not have to be machined by a milling center.

The angle between the screw channel 105 and the feed channel 111 advantageously lies in the range from 5° to 20°. In this range, both insertion of the fixing screw and the production of an abutment attachment having a lateral offset are possible in a technically particularly simple way.

FIG. 5 shows a further view of the milling blank 100. The securing section 103 is arranged on the axis of symmetry of the cylindrical milling section 109. For the milling blank 100 with angled feed channel 111, for the further processing by a milling center, it is possible to provide a CAD library for abutment design software, which takes into account the specific position and angling of the feed channel 111 within the milling blank 100. A base file forms a data set which defines a physical area in which the milling section may not be milled away. As a result, it is possible to prevent the channel wall thickness of the milled abutment attachment from becoming too thin.

For this purpose, it is possible to provide a computer program product which comprises a program which can be loaded directly into a memory of a programmable milling device, comprising programming means for milling a milling blank when the program is executed by the milling device.

All the features explained and shown in conjunction with individual embodiments of the invention can be provided in a different combination in the subject matter according to the invention, in order at the same time to implement the advantageous effects thereof.

The protective scope of the present invention is given by the claims and is not restricted by the features explained in the description or shown in the figures.

### LIST OF DESIGNATIONS

100 Milling blank

103 Securing section

105 Screw channel

107 Abutment attachment

109 Milling section

111 Feed channel

113 Conical section

115 Opening

117 Hexagonal section

119 Transition section

1. A milling blank for an abutment attachment which can be secured to a dental implant, comprising:
a securing section having a screw channel for a fixing screw for securing the milled abutment attachment to the dental implant; and
a milling section having a feed channel angled with respect to the screw channel for feeding the fixing screw to the screw channel.

2. The milling blank as claimed in claim 1, wherein the screw channel comprises a conical section for the insertion of a fixing screw with conical neck.

3. The milling blank as claimed in claim 2, wherein the angle of the feed channel with respect to the screw channel corresponds to half the opening angle of the conical section.

4. The milling blank as claimed in claim 2, wherein the conical section has a height of 1 mm to 5 mm.

5. The milling blank as claimed in claim 2, wherein the conical section is arranged in the securing section.

6. The milling blank as claimed in claim 2, wherein the conical section has a titanium nitride coating, a diamond coating or a carbon coating.

7. The milling blank as claimed in claim 1, wherein the milling section is cylindrical.

8. The milling blank as claimed in claim 7, wherein the securing section is arranged on the axis of the cylindrical milling section.

9. The milling blank as claimed in claim 1, wherein the feed channel merges seamlessly into the screw channel.

10. The milling blank as claimed in claim 1, wherein an opening of the feed channel is located in the edge region of a surface of the milling section that is opposite the securing section.

11. The milling blank as claimed in claim 1, wherein the securing section widens toward the milling section.

12. The milling blank as claimed in claim 1, wherein the securing section comprises a hexagonal section for insertion into a hexagonal recess.

13. The milling blank as claimed in claim 1, wherein the angle between the screw channel and the feed channel lies in the range from 5° to 20°.

14. The method for producing an abutment attachment, comprising the step:
milling a milling blank as claimed in claim 1.

15. The computer program product which comprises a program which can be loaded directly into a memory of a programmable milling device, comprising programming means for milling a milling blank as claimed in claim 1, wherein the computer program product comprises a data set which defines a physical area around the angled feed channel within the milling blank in which no machining of the milling blank is carried out by the milling device.
